(19) United States
(12) Patent Application Publication
(10) Pub. No.: US 2017/0239805 A1
(43) Pub. Date: Aug. 24, 2017

(54) Hair Brush

(71) Applicant: Danielle Settembre, Mahopac, NY (US)

(72) Inventor: Danielle Settembre, Mahopac, NY (US)

(21) Appl. No.: 15/159,450

(22) Filed: May 19, 2016

Related U.S. Application Data
(60) Provisional application No. 62/297,212, filed on Feb. 19, 2016.

(51) Int. Cl. B25G 1/04; A46B 5/00; B25G 3/36; A46B 9/02

(52) U.S. Cl. CPC B25G 1/04; A46B 9/023; A46B 9/026; A46B 5/0095; B25G 3/36

(57) ABSTRACT

The present invention relates to a novel hair brush. The inventive hair brush comprises a base, a pole detachably connected to the base and a brush around the pole. The base and pole can be separated and the brush removed to be replaced with a new brush. This novel hair brush improves sanitary conditions because a new brush can be used on each new, e.g., person or animal.

This application claims priority from provisional application 62/297,212, filed Feb. 19, 2016, the contents of which are incorporated herein by reference in their entirety.

### BACKGROUND OF THE INVENTION

A hair brush can present sanitary issues. In a hair salon, for example, using the same brush on many people can spread bacteria, spores, lice and other undesirable elements from one client to others. In for example a home setting, brushing the hair of a child with lice can spread the like to other children (or adults) if the brush is used on them. With animals, such as with pet grooming, the use of the same brush on different animals can spread fleas, lice, spores and the like from one animal to the next.

The brush can be cleaned after each use but this will not necessarily remove all the bacteria, spores, lice, fleas and other undesirable elements from the brush. The only sure way to remove these elements is to sterilize the brush. Sterilization, however, can be time consuming, expensive and damage the hair brush.

Accordingly, there is a need to provide for a hair brush which will not spread bacteria, fleas, spores and undesirable elements from one person or animal to the next. There is a further need to provide for a hair brush which does not spread these undesirable elements without the need for sterilization after each use.

### SUMMARY OF THE INVENTION

The above needs are met by providing for a hair brush where the brush element can be removed and discarded after each use, to be replaced with a new, clean brush. In one embodiment, the inventive hair brush comprises a handle or base, a pole removably attached to the base and a brush element around the pole. The handle or base and pole can be separated and the brush removed from the pole, to be replaced with a new brush.

### BRIEF DESCRIPTION OF THE DRAWINGS

FIG. 1 is a side view of a fully assembled hair brush of the instant invention.

FIG. 2a and FIG. 2b are side views of the handle or base element and the pole element of the inventive hair brush, where the handle or base and pole are separated. FIG. 2a and FIG. 2b show different embodiments of this arrangement. FIG. 2b shows a cross-sectional view of the base.

FIG. 3a FIG. 3b and FIG. 3c show three representative brush elements to use with the inventive hair brush, a narrow brush, a medium brush and a large brush.

### DETAILED DESCRIPTION OF THE INVENTION

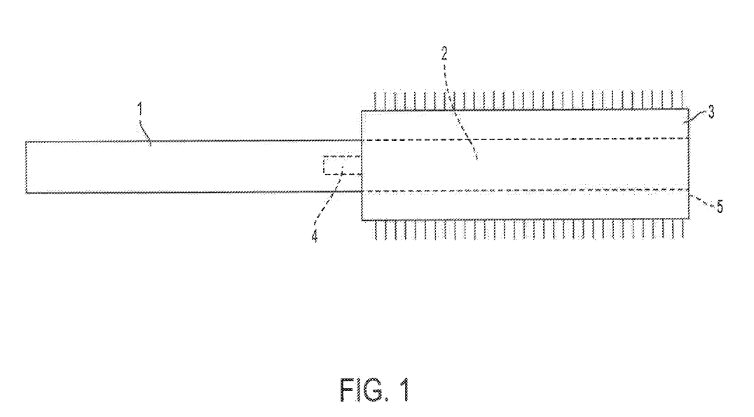

FIG. 1 shows a fully assembled hair brush of the present invention. It includes a base (1), a pole (2) attached to the base (1) and a disposable brush (3) on or around the pole (2). Also shown (4) is one way to detachably secure the pole (2) to the base (1). Finally, an attachment (5) is shown, here at the top of the pole (2) to attach the brush (3) to the pole (2).

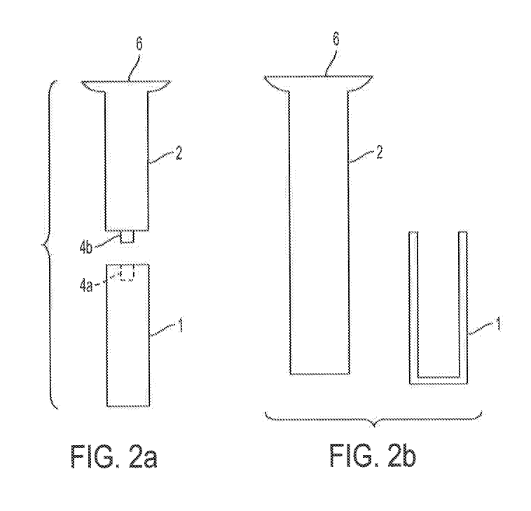

FIG. 2a shows the base (1) and pole (2) separated. An attachment (4a, 4b) is also shown to detachably connect the pole (2) to the base (1). In this embodiment, the attachment (4a, 4b) comprises a male portion (4b) protruding from the bottom of the pole (2) and a female portion (4a) in the top of the base (1). The male portion (4b) and female portion (4a) are configured so they fit snugly together. Of course, the attachment could be in a reverse configuration, where the male portion (4b) protrudes from the top of the base (1) and the female portion (4a) is placed in the bottom of the pole (2).

The attachment (4a, 4b) can optionally include a push button (not shown) to more securely attach the pole (2) to the base (1). For example, a ball and spring can be provided for in the male portion (4b) of the attachment and a receiving portion can be provided for in a wall of the female portion (4a). When the pole (2) and base (1) are attached or connected the ball engages the receiving portion securing the pole (2) to the base (1). The pole (2) can be disconnected from the base (1) by pushing in on the ball and pulling the base (1) and pole (2) apart.

The base (1) and pole (2) can be detachably connected in other ways. For example, a locking mechanism can be used where the base (1) and pole (2) are connected and twisted, locking the pole (2) to the base (1). In the alternative, the male (4b ) and female (4a) portions of the attachment can have matching threads so that the base (1) and pole (2) can be screwed together.

The above are representative examples of attachments to detachable connect the base (1) and the pole (2). Other ways to attach these elements come within the scope of this invention, so long as the attachment allows the pole (2) and base (1) to be detachably connected.

An alternative embodiment of the base (1) and pole (2) is shown in FIG. 2b. In this embodiment, the pole (2) slides part of the way into or, in the embodiment shown in FIG. 2b, all the way into the base (1). In this embodiment, the interior shape of the base (1) is configured to match the cross-sectional shape of that portion of the pole (2) being inserted into it. A sufficient portion of the pole (2) is left protruding from the base (1) to accept the brush (3). This has the advantage of strengthening the assembled brush because the attachment (4a, 4b) shown in FIG. 2a can be a point of weakness where the brush can break. Also, the pole (2) and base (1) can optionally include a push button, locking mechanism, threads and the like, as discussed above, to more securely hold the pole (2) to the base (1).

Referring again to FIG. 1, there is shown an attachment (5) at the top of the pole (2) for attaching to a brush (3). This brush attachment (5) can be a clip or any other suitable attachment to attach the brush (3) to the pole (2). In an alternative embodiment, the attachment (5) is at the bottom of the pole (2).

FIG. 2 shows another embodiment for the pole (2). The pole terminates in a flange or cap (6). The flange or cap (6) functions to prevent the brush (3) from sliding off of the pole (2). In yet another embodiment, the top of the pole (2) can be of a wider diameter then the rest of the pole (2) which will also prevent the brush (3) from sliding off.

The base (1) can also be configured to prevent the brush (3) from sliding off of the base (1), if necessary. For example, the attachment (5) in MG. I can be used. In the alternative, the base (1) can be provided with a flange or cap at or near its top (not shown). In yet another alternative, the base (1) can be configured to be wider than the pole (2). Any of these embodiments will prevent the brush (3) from sliding off of the base (1).

The base (1) and pole (2) can be made of any conventional material, for example metal, ebony, wood or plastic, or combinations thereof (for example, an ebony base (1) and a plastic pole (2)). They can also be manufactured by conventional means. For example, if the base (1) and pole (2) are both plastic, they can be formed by injecting plastic into a mold.

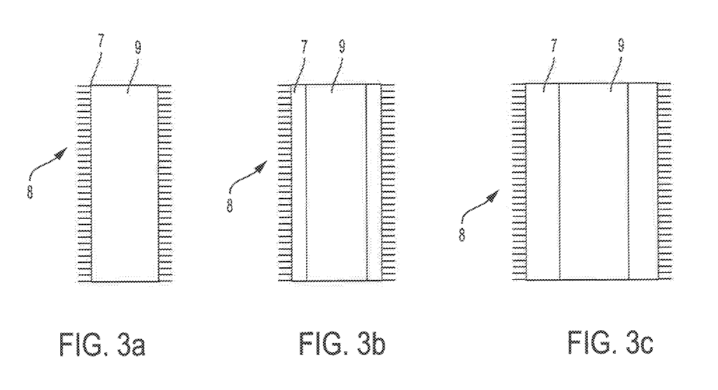

FIG. 3 shows examples of the brush (3) of FIG. 1. 3a is a small brush, 3b is a medium brush and 3c is a large brush. They are all round. The brushes (3a, 3b, 3c) can be made of conventional materials, such as plastic.

Each brush (3a, 3b, 3c) includes a wall (7), bristles (8) and an inner space (9). The bristles (8) in FIGS. 3a-3c, as well as those in FIG. 1, are shown at the sides of the brush. This is for illustrative purposes, it is understood that the bristles (8) will cover most or all of the surface of the brush (3 of FIG. 1, 3a-3c), as is the case with a conventional brush. One way to make the brushes (3a, 3b, 3c) different sizes is, as shown, to make the wall (7) a different thickness. In the alternative, the bristles (8) can be made longer or shorter. In addition, the wall (7) can be made of more than one material. For example, the inner portion of the wall (7) can be made of a hard plastic and the outer portion can be made of a softer plastic. The softer plastic can be adhered to the hard plastic for the entire length of the hard plastic or for just a portion of it, such as attached at the top and the bottom. Here, the bristles (8) can be attached to the soft plastic.

The brush (3a, 3b, 3c) also includes an inner space (9). This inner space (9) is configured to match the cross-sectional shape of the pole (2) so that the brush (3a, 3b, 3c) can slide over the pole (2). Preferably, the inner space (9) will be of a slightly larger diameter than the cross section of the pole (2) so that the brush (3a, 3b, 3c) fits snugly over the pole (2) and does not shake or rattle. Also, as shown in the Figures, in one embodiment the pole (2) extends the entire length of the brush (3a, 3b, 3c) and the flange or cap (6) may extend beyond the top of the brush (3a, 3b, 3c).

In one embodiment, the brush (3) is allowed to rotate about the pole (2). This can be accomplished by, for example, providing for a pole (2) with a circular cross section with the inner space (9) of the brush (3a, 3b, 3c) having a corresponding circular diameter or cross section.

In another embodiment, the brush (3a, 3b, 3c) does not rotate about the pole (2) but rather is held stationary. This can be accomplished in a number of ways. It can be accomplished by using the brush attachment (5) of FIG. 1. In the alternative, there can be a snug fit between the cap or flange (6) of the pole (2) and the cap or flange (not shown) of the base (1) with the hrush(3). Ridges can also be provided for, on the pole (2) and/or base (1), and channels in the brush (3a, 3b, 3c) or visa-versa. The grooves engage the channels preventing the rotation of the brush (3a, 3b, 3c) around the pole (2).

In yet another embodiment, the cross-section of the pole (2) is not round, but rather is oval, triangular, square, rectangular, pentagonal, etc. When the corresponding shape of the wall (7) defining the inner space (9) of the brush (3a, 3b, 3c) engages such a configuration, rotation is prevented.

The brushes (3a, 3b, 3c) shown in FIG. 3 are round. Other shaped brushes (3), such as flat brushes, can also be used. The cross section of the pole (2), however, might be too large or wide to accept a flat brush (3). In that case, a pole with a flatter or narrowed cross section. can be used. The round brushes (3a, 3b, 3c) can have their inner spaces (9) configured to correspond to this cross section or, in the alternative, a second pole (2) can be provided for with a narrow cross section to accept the flat brush (3). Preferably, the attachment (4b) on the second pole (2) should be the same as that on the first pole (2) so that both can be used with the same base (1).

In use, the hair brush as shown in FIG. 1 is used to brush the hair of, e,g., a person or animal. When done, the base (1) and pole (2) are separated and the brush (3) is removed and discarded. It is replaced with a new brush (3) on the pole (2), the pole (2) and base (1) are reconnected, and a clean sterile hair brush is ready for use on the next, e.g., person or animal.

In an alternative embodiment, a hair brush kit is provided for comprising a base (1), one or more poles (2), optionally of different cross sections to accept, for example, round and flat brushes (3), where the base (1) and pole(s) (2) can be detachably connected to each other, and a plurality of brushes (3). Depending on the need, a user would select and use the desired brush (3) to use. If a different styling need or different section of hair required the use of a different brush (3), the brush (3) then in use could be swapped out for a brush (3) of a desired design or configuration (for example, flat or round, fixed or rotatable about the pole (2)). In this case, since it is the same user, it would not be necessary to make the brushes (3) disposable, although they could be if so desired.

The foregoing relates to exemplary embodiments of the invention and modifications may be made without departing from the spirit and scope of the invention as set forth above and in the claims.

What is claimed is:

1. An improved hair brush comprising:
a. a base;
b. a pole detachably connected to the base; and
c. a removable brush on the pole;
wherein the base and pole can be separated and the brush removed.

2. The improved hair brush of claim 1 wherein the brush is disposable.

3. The improved hair brush of claim 1 further comprising an attachment on the pole to secure the brush to the pole.

4. The improved hair brush of claim 3 wherein the attachment is placed at a top portion of the pole.

5. The improved hair brush of claim 1 wherein the pole slides partially into the base, with a sufficient portion of the pole protruding from the base to accept the brush.

6. The improved hair brush of claim 1 wherein the pole slides all the way into the base, with a sufficient portion of the pole protruding from the base to accept the brush.

7. The improved hair brush of claim 1 wherein a top portion of the pole terminates in a portion which is of sufficient width to prevent the brush from sliding off of the pole.

8. The improved hair brush of claim 7 wherein the top portion of the pole terminates in a cap or a flange.

9. The improved hair brush of claim 1 wherein the base is of sufficient width to prevent the brush from sliding off.

10. The improved hair brush of claim 1 wherein the brush includes an inner space configured to match the pole's cross-sectional shape where the brush fits onto the pole so that the brush fits snugly on the pole.

11. The improved hair brush of claim 10 wherein the inner space of the brush and the cross-sectional shape of the pole are circular to permit the brush to rotate about the pole.

12. The improved hair brush of claim 10 wherein the inner space of the brush and the cross-sectional shape of the pole are non-circular to prevent the brush from rotating about the pole.

13. The improved hair brush of claim 1 wherein the brush is round.

14. The improved hair brush of claim 1 wherein the brush is flat.
